(19) United States
(12) Patent Application Publication
(10) Pub. No.: US 2022/0024609 A1
(43) Pub. Date: Jan. 27, 2022

(54) METHOD OF EXAMINING A COMPONENT

(71) Applicant: MTU Aero Engines AG, Munich (DE)

(72) Inventors: Andreas HIEBER, Munich (DE); Philipp FARAH, Freising (DE); Anna Carina KUEPPER, Munich (DE); Christian EICHLER, Olching (DE)

(21) Appl. No.: 17/378,918

(22) Filed: Jul. 19, 2021

(30) Foreign Application Priority Data
Jul. 21, 2020 (DE) 102020209086.6

(51) Int. Cl. B64F 5/60

(52) U.S. Cl. CPC B64F 5/60

(57) ABSTRACT

A method for examining a component with the steps:
Determining an actual value of a first parameter of a first characteristic of the component;
Determining an actual value of the first parameter of at least one further characteristic of the component;
Determining a first statistical characteristic variable of these actual values of the first parameter; and
Classifying the component on the basis of the first statistical characteristic variable and the actual values of the first parameter,
   wherein the component is classified in a predetermined quality class if the first statistical characteristic variable is outside a predetermined first characteristic variable range or at least one of these actual values of the first parameter is outside a predetermined first range of values.

### CROSS-REFERENCE TO RELATED APPLICATIONS

The present application claims priority under 35 U.S.C. § 119 of German Patent Application No. 102020209086.6, filed Jul. 21, 2021, the entire disclosure of which is expressly incorporated by reference herein.

### BACKGROUND OF THE INVENTION

### 1. Field of the Invention

The present invention relates to a method for examining a component, in particular an aircraft engine, on the basis of one or more predetermined ranges of values, a method for predetermining this range of values or these ranges of values and a system and a computer program product for carrying out a method described here.

### 2. Discussion of Background Information

Permissible ranges of values for parameters, for example a diameter, a position, length or area, a flatness or the like, of multiple existing component characteristics, for example grooves, holes or the like, are predetermined to date in a known manner according to internal practice, in particular in the form of target values and permissible tolerances.

According to internal practice, these values or tolerance ranges are (narrowly) predetermined in such a way that required properties, in particular functionality or reliability, of the component are (still) present even if the corresponding actual parameter values for all characteristics are at the edge of the corresponding range of values.

Such a worst case or such a correspondence of actual values of multiple component characteristics, for example diameters of similar holes or the like, is very unlikely, but leads, especially for aircraft engine components, to correspondingly narrow range of values or tolerances with a correspondingly high production effort.

The present invention can therefore be used with particular advantage for the examination of aircraft engine components, but without being limited to this.

It would therefore be advantageous to be able to reduce the production effort and/or to increase the reliability of examined components.

### SUMMARY OF THE INVENTION

The present invention provides a method for predetermining at least one range of values for a component examination described here with the characteristics of the independent method claim and a system and a computer program product for carrying out a method described here according to the independent product claims. Advantageous embodiments are the subject of the dependent claims.

According to an embodiment of the present invention, a method for the examination of a component in a preferred embodiment of a component for a, in particular one, aircraft engine(s) has the following steps:
Determining an actual value of a parameter of a characteristic of the component, which in the present case is referred to as the first parameter or first characteristic without limiting the generality;
Determining an actual value of this first parameter of at least one further characteristic of the component, preferably determining each (characteristic-specific) actual value of this first parameter of multiple other characteristics of the component;
Determining a statistical characteristic variable of these actual values of the first parameter, which in the present case is referred to as the first statistical characteristic variable without limiting the generality; and
Classification of the component on the basis of this first statistical characteristic variable and these actual values of the first parameter,
   wherein the component is classified in a predetermined quality class, preferably as defective or unsatisfactory, if at least one of the two conditions is met:
A1 the first statistical characteristic variable lies outside a predetermined characteristic variable range, which in the present case is referred to as the first characteristic variable range without limiting the generality;
B1 at least one of these actual values of the first parameter lies outside a predetermined range of values, which in the present case is referred to as the first range of values without limiting the generality.

Thus, an embodiment of the present invention is based on the idea, in addition to examining whether actual parameter values are within predetermined ranges of values or tolerance ranges, also of examining whether one or more statistical characteristic variables of these actual parameter values are (each) within a predetermined characteristic variable range.

If at least one of the actual parameter values is outside the corresponding range of values or tolerance range (condition B1), the component is classified in a corresponding predetermined quality class, in one embodiment as defective.

In addition, the component is also classified in this quality class, i.e., as defective in one embodiment, if the or at least one of the statistical characteristic variable(s) is outside the (respective) characteristic variable range (condition Al).

This is based on the idea that parameter values of component characteristics usually have statistical frequency distributions, in particular at least approximately normal distributions, and thus isolated actual parameter values which deviate strongly or more strongly from an average can be compensated by other approximately equally frequent actual parameter values which deviate from the average in opposite directions, and/or by the plurality of the actual parameter values which deviate from the average less (less strongly).

If, for example, the plurality of jointly acting holes have similar parameter values close to an arithmetic mean value, these holes can compensate in terms of functionality or reliability a few or isolated holes or parameter values which deviate from this mean value strongly or more strongly.

Therefore, if (in addition to the examination of the tolerance of the individual actual values according to condition B1) it is also checked (according to condition Al) or determined whether or that the actual parameter values have a corresponding or suf ficient statistical frequency distribution, is a result the reliability of examined components can be increased in one embodiment.

If a corresponding statistical frequency distribution is already taken as the basis for the tolerancing, advantageously larger tolerances can be predetermined and nevertheless required properties of components, in particular functionalities or reliability, can be realized, in particular ensured. Accordingly, a few or isolated strongly or more strongly deviating actual parameter values or larger tolerances may be allowed, provided that the actual distribution of the actual parameter values within the (set of) characteristics corresponds sufficiently to the statistical frequency distribution assumed for or at the time of tolerancing, which can be determined by examining the statistical characteristic variable(s). Due to (advantageously larger) predetermined ranges of values or tolerance ranges, the production effort can be reduced in one embodiment, in particular the rate of unsatisfactory components during component examination can be reduced despite sufficient warranty of required component properties, in particular component functionalities or component reliabilities.

In one embodiment the first characteristic is a structural, geometric, and/or manufacturing characteristic, in one development it has one or more inner or outer surfaces, preferably manufactured, in particular machined, in one embodiment it has functional areas and/or surfaces, in one embodiment a recess, in particular a groove, hole or the like, may in particular be such a surface or recess.

In one embodiment, the first parameter may have, in particular may be or describe or define, a structural, geometric and/or manufacturing parameter or variable, in a development
a structural, geometric or manufacturing dimension, in particular a distance or an extent, in particular a diameter, a length or an area or the like,
a shape, in particular a straightness, flatness, roundness, a cylindrical shape, a profile shape of a line, a profile shape of a surface or the like, or
a situation, in particular a position, coaxiality, symmetry, parallelism, perpendicularity, inclination, a (total) concentricity, a (total) axial run-out or the like.

In one embodiment, the first characteristic may be a groove, in particular for the attachment of vanes (feet), or a (supporting) edge of such a groove and the first parameter may be an (individual) flatness of such a supporting edge or a supporting edge spacing of such a groove.

The first characteristic and the further characteristic(s) are identical in one embodiment, wherein in a development they are of the same construction, type or function, thus in particular having functional areas and/or surfaces or recesses (identical, in particular in construction, type or function, if appropriate machined), wherein in one embodiment the first characteristic and the further characteristic(s) have the same (target) shapes and/or (target) dimensions.

In one embodiment, the method has the steps:
Determining an actual value of a parameter of the first characteristic of the component, which in the present case is referred to as the second parameter without limiting the generality;
Determining an actual value of this second parameter of the at least one further characteristic of the component, preferably determining a respective (characteristic-specific) actual value of this second parameter of the plurality of other characteristics of the component; and
Determining a statistical characteristic variable of these actual values of the second parameter, which in the present case is referred to as the second statistical characteristic variable without limiting the generality;
   wherein the component is classified on the basis (also) of the second statistical char acteristic variable and the actual values of the second parameter, wherein the component is (also) classified in the predetermined quality class, thus preferably as defective or unsatisfactory, if at least one of the two conditions is met:
A2 the second statistical characteristic variable lies outside a predetermined characteristic variable range, which in the present case is referred to as the second characteristic variable range without limiting the generality;
B2 at least one of these actual values of the second parameter lies outside a predetermined range of values, which in the present case is referred to as the-second range of values without limiting the generality,
i.e., if at least one of the conditions A1, B1, A2 or B2 is met.

As a result, in one embodiment one or more further or second parameters of the first characteristic and the other characteristic(s) can be examined in the same way and as a result in particular the reliability of examined components can be increased further or the production effort is further reduced, in particular with or by means of correspondingly greater tolerancing or by larger or increased second ranges of values.

In one embodiment the second parameter may have, in particular may be or describe or define, a structural, geometric and/or production parameter or variable, in a development
a structural, geometric or manufacturing dimension, in particular a distance or an extent, in particular a diameter, a length or area or the like,
a shape, in particular a straightness, flatness, roundness, cylindrical shape, a profile shape of a line, a profile shape of an area or the like, or
a situation, in particular a position, coaxiality, symmetry, parallelism, perpendicularity, inclination, a (total) concentricity, a (total) axial run-out or the like.

In one embodiment, the first characteristic may be a groove, in particular for the attachment of vanes (feet), or a (further) (supporting) edge of such a groove and the second parameter may be an (individual) flatness of such a supporting edge or a supporting edge spacing of such a groove.

In one embodiment, the method has the step:
Determining at least one statistical characteristic variable of the actual values of the first parameter, which in the present case is referred to as the third statistical characteristic variable without limiting the generality
   wherein the component is classified on the basis (also) of this third statistical characteristic variable, wherein the component is (also) classified in the predetermined quality class, preferably as defective or unsatisfactory, if at least the condition is met:
C1 this third statistical characteristic variable lies outside a predetermined character istic variable range, which in the present case is referred to as a third characteristic variable range without limiting the generality,
   i.e., if at least one of the conditions A1, B1 or C1 or, if appropriate, A2 or B2 is met. The term “third statistical characteristic variable” or “third characteristic variable range” does not imply the aforementioned second statistical characteristic variable or the aforementioned second characteristic variable range but is only used for a more compact representation.

In addition, or alternatively, in one embodiment the method has the step:
Determining at least one statistical characteristic variable of the actual values of the second parameter, which in the present case is referred to as the fourth statistical characteristic variable without limiting the generality
   wherein the component is classified on the basis (also) of this fourth statistical char acteristic variable, wherein the component is (also) classified in the predetermined quality class, preferably as defective or unsatisfactory, if at least the condition is met:
C2 this fourth statistical characteristic variable lies outside a predetermined characteristic variable range, which in the present case is referred to as a fourth characteristic variable range without limiting the generality.
   i.e., if at least one of the conditions A1, B1 or C2 or if appropriate A2, B2 or C1 is met. The term “fourth statistical characteristic variable” or “fourth characteristic variable range” does not imply the aforementioned third statistical characteristic variable or the aforementioned third characteristic variable range but is only used for a more compact representation.

By taking into account or examining one or more other statistical characteristic variables, in one embodiment the reliability of examined components can be further increased or the production effort can be further reduced, in particular with or by means of correspondingly greater tolerancing or larger or increased first or second ranges of values.

In one embodiment, the first statistical characteristic variable and/or the second statistical characteristic variable and/or the third statistical characteristic variable and/or the fourth statistical characteristic variable (each) have one or more statistical situational measures, in particular
at least one, preferably arithmetic, mean and/or
at least one quantile, in particular a median, a quartile, decile, percentile or the like.

In addition or alternatively, in one embodiment, the first statistical characteristic variable and/or the second statistical characteristic variable and/or the third statistical characteristic variable and/or the fourth statistical characteristic variable (each) has one or more statistical measures of dispersion, in particular at least one variance and/or at least one, preferably empirical, standard deviation.

By means of such statistical characteristic variables, in particular statistical characteristic variables which have at least one statistical situational measure and at least one statistical measure of dispersion, in one embodiment the presence of advantageous, in particular sufficient statistical frequency distributions or statistical frequency distributions which form the basis of or which are taken into account in the tolerancing or predetermination of the first and/or second range of values or tolerance range, can be examined particularly advantageously, in particular reliably and/or with little effort.

In addition or alternatively, in one embodiment, the first statistical characteristic variable and/or the second statistical characteristic variable and/or the third statistical characteristic variable and/or the fourth statistical characteristic (each) has one or more predetermined tolerance values, in particular
at least one upper tolerance value, in particular a maximum permissible upwards deviation from a target value or a maximum permissible value; and/or
at least one lower tolerance value, in particular a maximum permissible downwards deviation from a or the target value or a minimum permissible value; and/or
at least one tolerance value of the first range of values, in particular a maximum permissible deviation from a or the target value of the first range of values or a limit of the first range of values; and/or
at least one tolerance value of the second range of values, in particular a maximum permissible deviation from a or the target value of the second range of values or a limit of the second range of values; thus in particular,
an upper tolerance value of the first range of values, in particular a maximum permissible upwards deviation from a or the target-value of the first range of values or an upper limit of the first range of values; and/or
a lower tolerance value of the first range of-values, in particular a maximum permissible downwards deviation from a or the target value of the first range of values or a lower limit of the first range of values; and/or
an upper tolerance value of the second range of values, in particular a maximum permissible upwards deviation from a or the target value of the second range of values or an upper limit of the second range of values; and/or
a lower tolerance value of the second range of values, in particular a permissible downwards deviation from a or the target value of the second range of values or a lower limit of the second range of values.

By means of such statistical characteristic variables dependent on tolerance values of the ranges of values, in one embodiment the presence of advantageous statistical frequency distributions, in particular statistical frequency distributions which are sufficient or which form the basis of or are taken into account in the tolerancing or predetermination of the first and/or second range of values or tolerance range, can be examined particularly advantageously, in particular reliably and/or with little effort.

In addition or alternatively, in one embodiment the first characteristic variable range and/or the second characteristic variable range and/or the third characteristic variable range and/or the fourth characteristic variable range (each) depend on one or more predetermined tolerance values(s), in particular
on at least one upper tolerance value, in particular a maximum permissible value or a maximum permissible upwards deviation from a or the corresponding target value; and/or
at least one lower tolerance value, in particular a minimum permissible value or a maximum permissible downwards deviation from a or the corresponding target value; and/or
at least one tolerance value of the first range of values, in particular a limit of the first range of values or a maximum permissible deviation from a or the target value of the first range of values; and/or
at least one tolerance value of the second range of values, in particular a limit of the second range of values or a maximum permissible deviation from a or the target value of the second range of values;
   thus in particular,
an upper tolerance value of the first range of values, in particular an upper limit of the first range of values or a maximum permissible upwards deviation from a or the target value of the first range of values; and/or
a lower tolerance value of the first range of values, in particular a lower limit of the first range of values or a maximum- permissible downwards deviation from a or the target value of the first range of values; and/or
an upper tolerance value of the second range of values, in particular an upper limit of the second range of values or a maximum permissible upwards deviation from a or the target value of the second range of values; and/or
a lower tolerance value of the second range of values, in particular a lower limit of the second range of values or a maximum permissible downwards deviation from a or the target value of the second range of values.

By means of such characteristic variable ranges which are dependent on tolerance values of the ranges of values, in one embodiment the presence of advantageous statistical frequency distributions, in particular statistical frequency distributions which are sufficient for or which form the basis of or which are taken into account in the tolerancing or predetermination of the first and/or second range of values or tolerance range, can be examined particularly advantageously, in particular reliably and/or with little effort.

In one embodiment, the component is discarded if it is or has been classified in the predetermined quality class. As a result, in one embodiment the reliability of examined components can be further increased or the reject rate or the production effort can be further reduced, in particular with or by means of correspondingly greater tolerancing or larger or increased first or second ranges of values.

In another embodiment, the component is reworked or provided for this purpose, in particular separated out and/or marked, if it is or has been classified in the predetermined quality class. As a result, in one embodiment the reliability of examined components can be further increased or the reworking or the production effort can be reduced, in particular with or by means of correspondingly greater tolerancing or larger or increased first or second ranges of values.

Determining an actual value of a parameter in one embodiment involves measuring once or more times. A predetermined range, i.e. in particular the first range of values and/or the second range of values and/or the first characteristic variable range and/or the second characteristic variable range, can (each) be a range closed on one side or open on one side or a region closed on both sides or may only have an (upper or lower) limit (closed or open on one side) or an upper and a lower limit (closed on both sides).

According to an embodiment of the present invention, the first range of values is to be or is predetermined on the basis of or depending on or taking as a basis an assumed statistical frequency distribution, in a development of an assumed normal distribution, the actual values of the first parameter are to be or are predetermined within the characteristics of the component, in one embodiment on the basis of an assumed target value for the first and/or third statistical characteristic variable, in particular one or more of its components. In addition or alternatively, according to an embodiment of the present invention, the second range of values is to be or is predetermined on the basis of or depending on or taking as a basis an assumed statistical frequency distribution, in a development of an assumed normal ratio the actual values of the second parameter are to be or are predetermined within the characteristics of the component, in one embodiment on the basis of an assumed target value for the second and/or fourth statistical characteristic variable, in particular one or more of its components. In one embodiment, this assumed statistical frequency distribution, which is to be or is used as the basis for the predetermination of the first range of values, and/or this assumed statistical frequency distribution, which is to be or is used as the basis for the predetermination of the second range of values, (each) has multiple different actual parameter values or is different from an identity of all actual parameter values.

In one embodiment, the first range of values is to be or is increased if a greater dispersion of the actual values of the first parameter is to be or is assumed, and/or the second range of values is to be or is increased if a greater dispersion of the actual values of the second parameter is to be or is assumed, for example linearly as a function of a statistical measure of dispersion.

As a result, in one embodiment the reliability of examined components can be increased, or the production effort can be reduced.

According to an embodiment of the present invention, a system, in particular in hardware and/or software, in particular programmatic, is set up to carry out a method described herein and/or has:
Means for determining a or the first statistical characteristic variable of the determined actual values of a or the first parameter of a or the first characteristic and of at least a further characteristic or of the further characteristic(s) of the component; and/or
Means for classifying the component on the basis of the first statistical characteristic variable and the actual values of the first parameter, wherein the component is classified in a or the predetermined quality class if the first statistical characteristic variable is outside a or the predetermined first characteristic variable range or at least one of these actual values of the first parameter is outside a or the predetermined first range of values.

In one embodiment, the system or its means has:
Means for determining a or the second statistical characteristic variable of the determined actual values of the first parameter of the first characteristic and of the other characteristic(s) of the component; and/or
Means for classifying the component on the basis of the second statistical characteristic variable and the actual values of the second parameter, wherein the component is classified in the predetermined quality class if the second statistical characteristic variable is outside a or the predetermined second characteristic variable range or at least one of these actual values of the second parameter is outside a predetermined second range of values.

In addition or alternatively, in one embodiment the system or its means has:
Means for determining at least one or the third statistical characteristic variable of the determined actual values of the first parameter of the first characteristic and the further characteristic(s) of the component; and/or
Means for determining at least one or the fourth statistical characteristic of the determined actual values of the second parameter of the first characteristic and the further characteristic(s) of the component; and/or
Means for classifying the component on the basis of the third statistical characteristic, whereby the component is classified in the predetermined quality class if the third statistical characteristic variable is outside a predetermined third characteristic variable range; and/or
Means for classifying the component on the basis of the fourth statistical characteristic variable, wherein the component is classified in the predetermined quality class if the fourth statistical characteristic variable is outside a or the predetermined fourth characteristic variable range.

In addition or alternatively, in one embodiment the system or its means(s) has:
Means for predetermining the first range of values on the basis of a or the assumed statistical frequency distribution of the actual values of the first parameter within the characteristics of the component and/or the second range of values on the basis of a or the assumed statistical frequency distribution of the actual values of the second parameter within the characteristics of the component.

A means within the meaning of the present invention may be in the form of hardware and/or software technology, in particular a processing unit, in particular a digital microprocessor unit, in particular at least one CPU, preferably with a data or signal connection to a memory and/or a bus system, and/or may have one or more programs or program modules. The processing unit may be designed to process commands implemented as a program stored in a memory system, to acquire input signals from a data bus and/or to issue output signals to a data bus. A memory system may have one or more, in particular different, memory media, in particular optical, magnetic, solid-state and/or other non-volatile media. The program may be designed in such a way that it embodies or is able to perform the methods described herein, so that the processing unit can carry out the steps of such methods. A computer program product in one embodiment may have an in particular non-volatile memory medium for storing a program or with a program stored on it, in particular, wherein the execution of this program causes a system or a controller, in particular a computer, to carry out a method described herein or one or more of its steps.

In one embodiment, one or more, in particular all, steps of the method are carried out entirely automatically or partially automatically, in particular by the system or its means.

### BRIEF DESCRIPTION OF THE DRAWINGS

Further advantageous developments of the present invention result from the subordinate claims and the following description of preferred embodiments. For this purpose the figures show partially schematized representations as follows:

FIG. 1 shows a component examined by a method according to an embodi ment of the present invention;

FIG. 2: shows a detail of the component of FIG. 1;

FIG. 3 shows the method for examining the component; and

FIG. 4 shows a system for carrying out the method.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

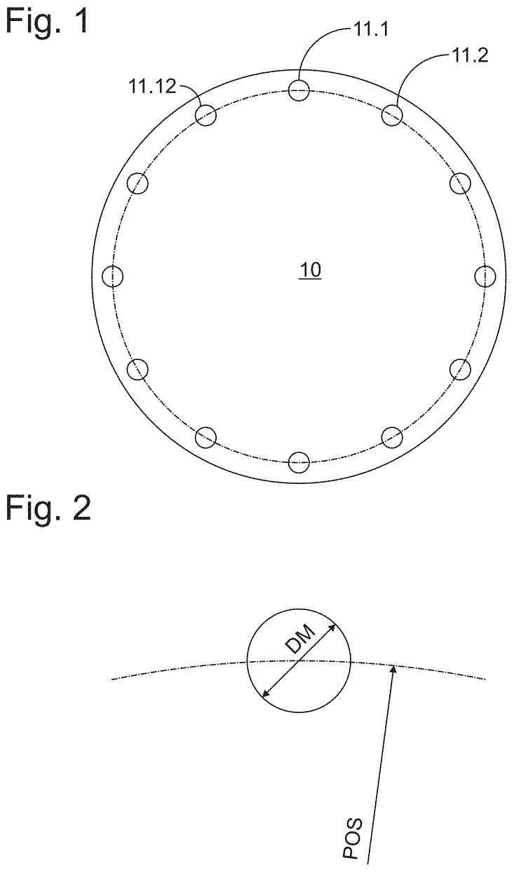

FIG. 1 shows a rotor 10 of a gas turbine with 12 similar holes 11.1, 11.2, . . . , 11.12 in an axial top view, FIG. 2 shows the hole 11.1 by way of example.

The hole 11.1 represents a first characteristic of the rotor 10, the holes 11.2, . . . , 11. 12 each represent another characteristic of the rotor.

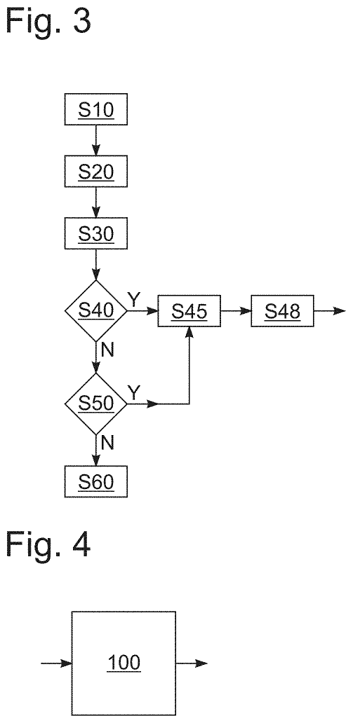

For parameters of these characteristics 11.1, 11.2, . . . ,11.12, S10 (cf. FIG. 3) target values as well as upper and/or lower tolerance values are predetermined, which define corresponding ranges of values or tolerance ranges.

For example, for a first parameter DM in the form of a diameter of the holes, a target value of 5 mm, a maximum permissible upwards deviation of 0.1 mm or an upper tolerance value OT_{DM} of 5.1 mm and a maximum permissible deviation downwards of 0.1 mm or a lower tolerance value UT_{DM} of 4.9 mm is predetermined, which defines a first range of values or of tolerance range [4.9 mm; 5.1 mm]. Alternatively, for example, the flatness of functional surfaces of grooves or the like could be predetermined, wherein the value of the corresponding flatness indicates in a customary manner the permissible plane spacing between two parallel surfaces, which define between themselves a gap-shaped tolerance zone in which the functional surface is to lie.

Also by way of example, for a second parameter POS in the form of a hole circle diameter or a radial distance from the respective hole to the rotor center, a target value of 200 mm, a maximum permissible upwards deviation of 0.2 mm or an upper tolerance value OT_{POS} of 200.2 mm is predetermined and a maximum permissible downwards deviation of 0.2 mm or a lower tolerance value UT_{POS} of 199.8 mm is predetermined, which defines a second range of values or tolerance range [199.8 mm; 200.2 mm].

Initially, without taking into account statistical frequency distributions of the parameter values in a known manner, for example on the basis of corresponding strength calculations, safety parameters and the like, respective tolerance fields are predetermined for the parameters DM, POS. This is familiar to the person skilled in the art and therefore does not need to be described further here.

Then, in step S10, a normal distribution with an average value and a standard deviation is used as the basis for each of the parameters and the corresponding tolerance field mentioned above is increased in proportion to the standard deviation, which provides the aforementioned range of values or tolerance range [4.9 mm; 5.1 mm] for the parameter DM and [199.8 mm; 200.2 mm] for the parameter POS.

Step S10 thus provides a method for predetermining the first range of values [4.9 mm; 5.1 mm] for the first parameter DM and the second range of values [199.8 mm; 200.2 mm] for the second parameter POS.

In a step S20, the actual values of the parameters DM, POS are determined.

In a step S30, a first statistical characteristic variable for the first parameter DM is determined in the form of the customarily defined arithmetic mean M_{DM} over all 12 holes, i.e. the actual-values DMᵢ, i=11.1, . . . , 11.12:

M_{DM}=(Σ_{i=11.1}^{11.12}DMᵢ)/12

and a third statistical characteristic variable is determined in the form of a statistical index IO_{DM} over all holes i=11.1, . . . , 11.12:

IO_{DM}=(OT_{DM}−M_{DM})/(3s·_{DM})

with the customarily defined (empirical) standard deviation

s_{DM}=[Σ_{i=11.1}^{11.12}(DMᵢ−M_{DM})²/12]^{0.5}

and another third statistical characteristic variable is determined in the form of another statistical index IU_{DM} over all holes i=11.1, . . . ,11.12:

IU_{DM}=(M_{DM}−UT_{DM})/(3s·_{DM}).

It can be seen that the first statistical characteristic variable is the statistical mean value M_{DM} , the one third statistical characteristic variable IO_{DM} is a statistical situational measure in the form of this mean value, a statistical measure of dispersion in the form of the standard deviation DM and the upper tolerance value OT_{DM} of the first parameter DM or the first range of values and the other third statistical characteristic variable has the lower tolerance value UT_{DM} of the first parameter DM or the first range of values instead of the upper tolerance value.

In addition, in step S30 a second statistical characteristic variable is determined for the second parameter POS in the form of the arithmetic mean M_{POS} over all 12 holes, i.e. the actual-values POSᵢ,i=11.1, . . . , 11.12:

M_{POS}=(Σ_{i=11.1}^{11.12}POSᵢ)/12

a fourth statistical characteristic variable is determined in the form of a statistical index IO_{POS} over all holes i=11.1, . . . ,11.12:

IO_{POS}=(OT_{POS}−M_{POS})/(3s·_{POS})

with the (empirical) standard deviation

s_{POS}=[Σ_{i=11.1}^{11.12}(POSᵢ−M_{POS})²/12]^{0.5}

and another fourth statistical characteristic variable is determined in the form of another statistical index IU_{POS} over all holes i=11.1, . . . ,11.12:

IU_{POS}=(M_{POS}−UT_{POS})/(3s·_{POS}).

Then, in a step S40, it is checked whether at least one of the actual values of the parameters DM, POS is outside the corresponding range of values, i.e. in particular one of the actual values DMᵢ, i=11.1, . . . , 11.12 outside the first range of values [4.9 mm; 5.1 mm] or one of the actual values POSᵢ, i=11.1, . . . ,11.12 outside the second range of values [199.8 mm; 200.2 mm].

If this is the case (S40: “Y”), the rotor is classified as defective (S45) and, if appropriate, is separated out or reworked (S48).

Otherwise (S40: “N”) it is checked in a step S50 whether the first statistical characteristic variable M_{DM} is outside a predetermined first characteristic variable range, which depends on the upper tolerance value OT_{DM} and the lower tolerance value UT_{DM} of the first range of values, in the exemplary embodiment whether the following applies:

M_{DM}>OT_{DM}+0.05 mm or M_{DM}<UT_{DM}−0.05 mm,

whether the second statistical characteristic variable M_{POS} is outside a predetermined second characteristic variable range, which depends on the upper tolerance value OT_{POS} and the lower tolerance value UT_{POS} of the second range of values, in the exemplary embodiment whether:

M_{POS}>OT_{POS}+0.1 mm or M_{POS}<UT_{POS}−0.1 mm,

whether one of the third statistical characteristic variables IO_{DM}, IU_{DM} is outside a predetermined corresponding third characteristic variable range, in the exemplary embodiment whether:

IO_{DM}<1.5 or IU_{DM}>1.5

or one of the fourth statistical characteristic variables IO_{POS}, IU_{POS} is outside the corresponding fourth characteristic variable range, in the exemplary embodiment, whether the following applies:

IO_{POS}<1 or IU_{POS}>1

If at least one of these conditions is met (S50: “Y”), the rotor is also classified as defective (S45) and, if appropriate, is separated out or reworked (S48).

If all actual values are within the predetermined range of values or tolerance range (S40: “N”) and all statistical characteristic variables are within the predetermined characteristic variable ranges (S50: “N”), the rotor has passed this component examination (S60).

FIG. 4 shows a system for at least partially automated embodiment of the method described above in the form of a computer 100, which is set up to classify the rotor as a reject or good on the basis of entered actual values.

Although exemplary implementations have been explained in the preceding description, it should be noted that a variety of variations are possible. In addition, it should be noted that the exemplary embodiments are only examples that are not intended to restrict the scope of protection, the applications and the design in any way. Rather, the preceding description gives the person skilled in the art a guide for the implementation of at least one exemplary embodiment, wherein various changes, in particular with regard to the function and arrangement of the described components, can be made without departing from the scope of protection as it results from the claims and equivalent combinations of features.

### REFERENCE CHARACTER LIST

10 rotor (component)

11.1,

11.2,

11.12 hole (characteristic)

100 computer (system)

1.-9. (canceled)

10. A method for examining a component, wherein the method comprises:
determining an actual value of a first parameter of a first characteristic of the component;
determining an actual value of the first parameter of at least one further characteristic of the component;
determining a first statistical characteristic variable of the actual values of the first parameter; and
classifying the component on the basis of the first statistical characteristic variable and the actual values of the first parameter, the component being classified in a predetermined quality class if the first statistical characteristic variable is outside a predetermined first characteristic variable range or at least one of the actual values of the first parameter is outside a predetermined first range of values.

11. The method of claim 1, wherein the method further comprises:
determining an actual value of a second parameter of the first characteristic of the component;
determining an actual value of the second parameter of the at least one further characteristic of the component; and
determining a second statistical characteristic variable of the actual values of the second parameter;
the component being classified on the basis of the second statistical characteristic variable and the actual values of the second parameter and being classified in the predetermined quality class if the second statistical characteristic variable is outside a predetermined second characteristic variable range or at least one of the actual values of the second parameter is outside a predetermined second range of values.

12. The method of claim 11, wherein the method further comprises:
determining at least a third statistical characteristic variable of the actual values of the first-parameter; and/or
determining at least a fourth statistical characteristic variable of the actual values of the second parameter;
the component being classified on the basis of the third statistical characteristic variable and/or the fourth statistical characteristic variable and being classified in the predetermined quality class if the third statistical characteristic variable is outside a predetermined third characteristic variable range or if the fourth statistical characteristic variable is outside a predetermined fourth characteristic variable range.

13. The method of claim 12, wherein the first statistical characteristic variable and/or the second statistical characteristic variable and/or the third statistical characteristic variable and/or the fourth statistical characteristic variable has at least a statistical situational measure, at least a statistical measure of dispersion and/or at least a predetermined tolerance value of the first and/or second range of values, and/or the first characteristic variable range and/or the second characteristic variable range and/or the third characteristic variable range and/or the fourth characteristic variable range depends on at least one predetermined tolerance value of the first and/or second range of values.

14. The method of claim 13, wherein the statistical situational measure is an average and/or a quantile.

15. The method of claim 13, wherein the statistical measure of dispersion is a variance or a standard deviation.

16. The method of claim 13, wherein the predetermined tolerance value is an upper tolerance value and/or a lower tolerance value.

17. The method of claim 10, wherein the component is discarded or reworked if it has been classified in the predetermined quality class.

18. The method of claim 10, wherein the first and/or second range of values is predetermined according to a method in which the first range of values is predetermined on the basis of an assumed statistical frequency distribution of the actual values of the first parameter within the characteristics of the component and/or the second range of values is predetermined on the basis of an assumed statistical frequency distribution of the actual values of the second parameter within the characteristics of the component.

19. The method of claim 10, wherein the component is an aircraft engine.

20. A system for examining a component, wherein the component is set up for carrying out the method of claim 10 and/or comprises:
elements for determining a first statistical characteristic variable of determined actual values of a first parameter of a first characteristic of the component and at least one further characteristic of the component; and/or
elements for classifying the component on the basis of the first statistical characteristic variable and the actual values of the first parameter, the component being classified in a predetermined quality class if the first statistical characteristic variable is outside a predetermined first characteristic variable range or at least one of the actual values of the first parameter is outside a predetermined first range of values.

21. A computer program product, wherein the product comprises a program code which is stored on a medium readable by a computer, for carrying out the method of claim 10.
